(19) United States
(12) Patent Application Publication
(10) Pub. No.: US 2008/0286596 A1
(43) Pub. Date: Nov. 20, 2008

(54) METAL FABRIC BASED MULTIPLE PLY LAMINATED STRUCTURE

(75) Inventors: Norman M. Soep, Highland Park, IL (US); Steven Alan Bouse, Elmhurst, IL (US); Michelle Brandner, Woodridge, IL (US); David A. Colbert, Cary, IL (US); Terrence P. Kane, Glen Ellyn, IL (US); Frank J. Krejsa, Cicero, IL (US); Mark Rak, Orlando Park, IL (US); Kurt H. Schild, III, Wadsworth, IL (US); Alexander Krupnik, Northbrook, IL (US)

Correspondence Address: ROSENBAUM & ASSOCIATES, P.C., 650 DUNDEE ROAD, SUITE #380, NORTHBROOK, IL, 60062, US

(73) Assignee: Global Materials Technology, Inc., Palatine, IL (US)

(21) Appl. No.: 11/749,059

(22) Filed: May 15, 2007

(51) Int. Cl. B32B 15/00; B29C 65/00

(52) U.S. Cl. 428/549; 156/298

(57) ABSTRACT

The invention is multilayer laminate comprising at least one scouring layer and at least one nonmetal layer; wherein the scouring layer includes a scouring surface and a laminating surface such that the laminating surface is laminated to the nonmetal layer.

### BACKGROUND OF THE INVENTION

The field of the invention is nonwoven fabrics, and more specifically related to scouring surfaces.

There are a variety of scouring pads known in the art, for example, there are abrasive steel wool pads, consisting of a bundle of metal fibers. However, the wet steel wool pads rust and deteriorate within one to two days from the time they are initially used. Consequently, wet steel wool pads quickly lose their cleaning ingredients and rust badly, so a steel wool pad can only be used once or twice and thrown away. Additionally, there are scouring pads with polymer fibers. Such scouring pads lose their scouring ability relatively quickly, due to the low scouring nature of polymer fibers. In sum, the shortcomings and disadvantages of scouring pads are resolved by the present invention

### SUMMARY OF THE INVENTION

The invention is multilayer laminate comprising at least one scouring layer and at least one nonmetal layer; wherein the scouring layer includes a scouring surface and a laminating surface such that the laminating surface laminates to the nonmetal layer; and the scouring layer comprises at least one ply layer including an interengaged mixture of metal fibers, wherein the metal fibers include a rough barbed outer surface with irregular shaped cross-sections varied along the lengths of the metal fibers.

In one embodiment of the invention, the multilayer laminate further comprises the ply layer including at least one composite nonwoven ply, wherein the composite nonwoven ply includes an interengaged mixture of metal fibers and nonmetal fibers, and the metal fibers include a rough barbed outer surface with irregular shaped cross-sections varied along the lengths of the metal fibers. In another embodiment of the invention the multilayer laminate further comprises the ply layer including at least one nonwoven ply, wherein the nonwoven ply includes an interengaged mixture of metal fibers, wherein the metal fibers are oriented isotropically. In another embodiment of the invention, the multilayer laminate further comprises the ply layer including at least one cross layered ply, wherein the cross layered ply includes a plurality of continuous metal fibers lapped in a cross-machine direction to form metal fibers into a bias-oriented needle punched web. In another embodiment of the invention, the multilayer laminate further comprises the ply layer including at least one spunbonded adhesive fiber scrim ply, at least one nonwoven ply, or at least one polyester scrim ply.

The invention is also a method of making a multilayer laminate comprising the steps of: forming at least one ply layer with a plurality of metal fibers having barbed rough outer surfaces and irregular cross sectional diameters varying along the length of the metal fibers; incorporating the ply layer into a scouring layer with a scouring surface and a laminating surface; and laminating the laminating surface to a nonmetal layer. In one embodiment of the invention, the forming the ply layer step further comprises: providing a mass of loose metal fibers having barbed rough outer surfaces and irregular cross-sectional diameters varying along the length of the fibers; applying a lubricant to the metal fibers in sufficient quantities so that irregular cross sections and barbed rough outer surfaces retain the lubricant and the lubricant substantially coats the metal fibers; forming a homogenous fiber mass of the lubricated metal fibers; needle punching the homogenous fiber mass to interengage the fibers and to form at least one needled roving ply; and laminating the needled roving ply to the nonmetal layer.

In another embodiment of the invention, the method of making a multilayer laminate further comprises the forming the ply layer step including providing a mass of loose metal fibers having barbed rough outer surfaces and irregular cross-sectional diameters varying along the length of the fibers; applying a lubricant to the metal fibers in sufficient quantities so that irregular cross sections and barbed rough outer surfaces retain the lubricant and the lubricant substantially coats the metal fibers; forming a homogenous fiber mass from the lubricated metal fibers with a textile apparatus; carding the lubricated fibers on a garnett to form a fiber web; lapping the fiber web to form multiple layers of the fiber web; and needle punched the multiple layers to interengage the fibers of respective layers to form at least one nonwoven ply. In another embodiment of the invention the method of making a multilayer laminate further comprises the forming the ply layer step including: providing a mass of loose nonmetal fibers and metal fibers; applying a lubricant to the metal fibers in sufficient quantities so that irregular cross sections and barbed rough outer surfaces retain the lubricant and the lubricant substantially coats the metal fibers; forming a homogenous fiber mass from the lubricated metal fibers with a textile apparatus; carding the lubricated fibers on a garnett to form a fiber web; lapping the fiber web to form multiple layers of the fiber web; and needle punching the multiple layers to interengage the fibers of respective layers to form at least one composite nonwoven ply.

### BRIEF DESCRIPTION OF THE FIGURES

FIG. 1 is a cross section of one embodiment of the invention.

FIGS. 2A-2G are enlarged cross sections of the different ply layers.

FIG. 3 is an enlarged perspective view of the metal fibers or nonmetal fibers in the different ply layers

FIG. 4 is a schematic view of the precard machine.

FIG. 5 is a schematic view of the needle punching machine.

FIG. 6 is a schematic view of the carding machine.

FIG. 7 is a schematic view of the formation of the composite nonwoven ply.

FIG. 8 is a schematic view of the needle punching step in the formation of the composite nonwoven ply.

FIG. 9 is a schematic view of the heat fusing step.

FIG. 10 is an aerial view of the lapping machine cross layering a web structure.

FIG. 11 is a cross section of one embodiment of the invention.

FIG. 12 is a cross section of one embodiment of the invention.

FIG. 13 is a cross section of one embodiment of the invention.

FIG. 14 is a cross section of one embodiment of the invention.

FIG. 15 is a cross section of one embodiment of the invention.

FIG. 16 is a cross section of one embodiment of the invention

### DETAILED DESCRIPTION OF THE PREFERRED EMBODIMENTS

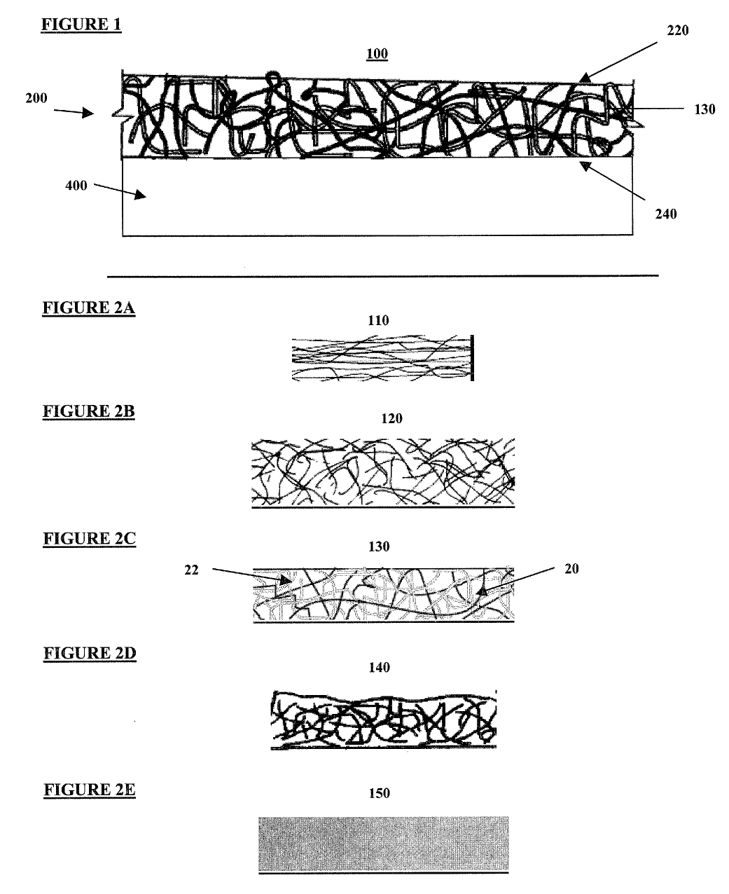

Generally speaking, the invention is a multilayer laminate 100 comprising at least one scouring layer 200 and at least one nonmetal layer 400, as shown in FIG. 1. The scouring layer 200 includes a scouring surface 220 and a laminating surface 240. The scouring layer 200 is constructed with at least one ply layer. The nonmetal layer 400 may be an absorbent layer, such as a natural or synthetic sponge or the like. Alternatively, the nonmetal layer 400 may be a plastic gripping device or a woven cloth pad. The laminating surface 240 of the scouring layer 200 is laminated to the nonmetal layer 400. “Laminating” means securing two layers together by any adhering process, such as heat application, adhesives, pressure, mechanical bonding, or any combinations thereof. Laminating forms a bond between two surfaces; this may be a thermal bond, a chemical bond, or a mechanical bond. Adhesives may be any suitable material that is compatible with the scouring layer and the nonmetal layer. Laminating the scouring layer 200 to the nonmetal layer 400 increases the stability, strength, and abrasiveness of the scouring layer 200.

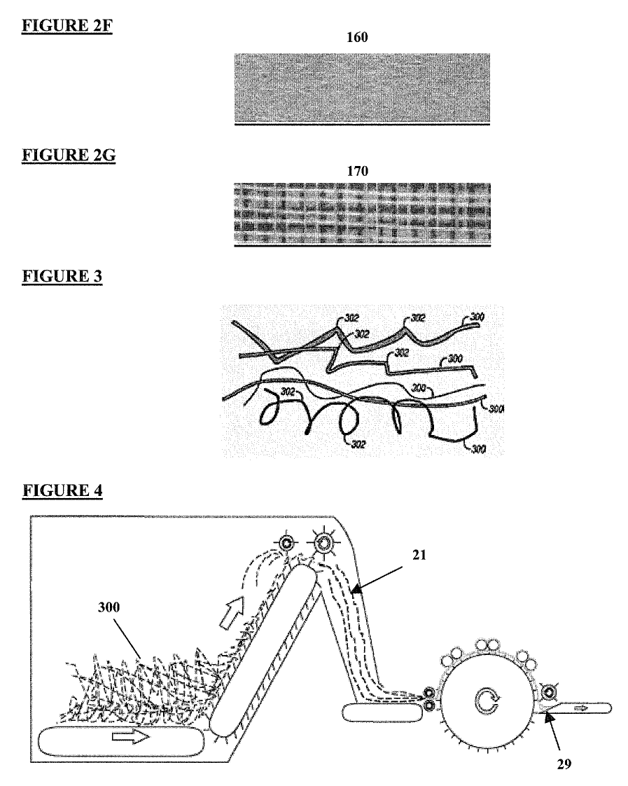

The scouring layer 200 includes at least one ply layer. A “ply layer” is a homogenous and distinct layer or a multilayer ply textile. As shown in FIGS. 2A-2H, generally, there are several types of ply layers which can be used with the invention, such as a needled roving ply 110, a nonwoven ply 120, a composite nonwoven 130, a cross layered ply 140, a polyester scrim ply 160, a spunbonded adhesive fiber scrim ply 170, or a nylon scrim 180. In FIG. 2A, the needle-roved ply 110 comprises a layer of continuous metal fibers needle punched into a web with all fibers running roughly parallel in one direction. In FIG. 2B, the non-woven ply 120 comprises a single type of metal fiber oriented isotropically or without distinct direction by mechanical carding, lapping, and needle punching together the metal fibers. In FIG. 2C, the composite nonwoven ply 130 comprises at least one metal fiber and at least one nonmetal fiber, where the metal and nonmetal fibers are oriented isotropically by mechanical carding, lapping, and needle punching. In FIG. 2D, the cross layered ply 140 comprises a layer of continuous metal fibers lapped in a cross-machine direction to form fibers into a bias-oriented needle punched web. In FIG. 2E, the polyester scrim 150 comprises mechanically bonded needle punched polyester fibers of a given denier and basis weight. In FIG. 2F, the spunbonded adhesive scrim fiber 160 is a special laminating adhesive in low melt fiber web form. In FIG. 2G, the nylon scrim ply 170 comprises nylon fibers woven together of a given denier and basis weight. The needled roving ply 10, the nonwoven ply 120, the composite nonwoven ply 130, and the cross layered ply 140 include metal fibers.

It should be appreciated that the scouring layer 200 of the invention can be constructed with any number of ply layers in any combination to achieve the desired performance of scouring a surface. The ply layers can be laminated in an order where the scouring surface 220 includes a ply layer with sufficient scouring ability, and the laminating surface 240 includes a ply layer with sufficient laminating ability to the nonmetal layer 400. One of ordinary skill in the art can determine what scouring application requires which ply layers and adjust them and combine them accordingly. Ply layers can be selected to increase the structural stability of the scouring layer. Also, the combination of ply layers can provide a synergistic effect to enhance the strength and durability of the scouring layer. The ply layers 110-140 are constructed with a plurality of metal fibers to give a superior strength, density, and durability to the scouring layer as to withstand repeated use and wear and tear.

### Metal Fiber

The ply layers 110-140 include a plurality of metal fibers 300, as shown in FIG. 3. The metal fibers 300 have an irregular cross-section and rough outer surfaces with barbs 302 formed on the outer surfaces. The irregular cross-sections vary continuously along the length of the resulting fibers to provide generally curled metal fibers. The curled and barbed nature of the metal fibers allows strong interengagement with each other and strong scouring surfaces. The metal fibers 300 are preferably produced by shaving a metal member with a succession of serrated blades, as disclosed in commonly assigned U.S. Pat. Nos. 6,249,941 and 5,972,814, which is hereby incorporated by reference. A suitable lubricant, such as oil, is preferably applied to the metal member as it is being shaved by the blades in sufficient quantity so that the metal fibers retain on their outer surface a carding-effective amount of the oil or lubricant. “Carding-effective amount” of oil or lubricant means that the metal fibers, when blended with the nonmetal fibers, can be carded without substantial breakage or disintegration. The lubricant optionally may be applied after the metal fibers are formed. The commonly assigned U.S. Pat. No. 6,249,941 discloses the process for shaving a metal bar to produce lubricated metal fibers and the use of such lubricated metal fibers. A carding-effective amount of oil generally may be in the range of about 0.3 to 1.0 wt. % oil, more preferably about 0.4 to 0.7 wt. %, based on the total weight of the metal fibers, although lesser or greater amounts may be used depending on the type and average diameter of the metal fibers and the amount and type of nonmetal fibers included in the blended fiber mixture. For example, as the weight percentage of nonmetal fibers relative to the metal fibers is decreased, the quantity of oil or lubricant necessary to provide a carding effective amount may tend to increase. Conversely, as the weight percentage of nonmetal fibers relative to metal fibers increases, the nonmetal fibers may act as a “carrier” for the metal fibers in the carding step, reducing the quantity of oil needed for carding without breakage of the metal fibers. Thus, a carding-effective amount of oil for carding various combinations and amounts of metal and nonmetal fibers can be readily determined on a case-by-case basis. Preferably, the metal fibers are made from stainless steel, as to prevent rusting of the scouring surface. However, the metal fibers 300 can also be made from bronze, carbon steel, copper, metal alloys, and other suitable metals that can be shaved into suitable metal fibers to suit a variety of scouring applications. The metal fibers can have an average cross sectional diameter of between about 25 and 125 microns. The metal fibers 300 are cut into staple lengths using a suitable metal fiber cutting apparatus to give the metal fibers a predetermined length, as shown in FIG. 4. The cut fibers 21 are then fed into conventional textile apparatus which separates and blends the mass of fibers 21 in order to form a homogenous blend of fiber 29, as shown in FIG. 4. The homogenous fiber mass 29 can then be used in the construction of the nonwoven ply 120 and the composite nonwoven ply 130. Ply layers constructed with metal fibers 21 may be made of, but are not limited to, a needled roving, cross layered, carded construction processes. Some processes are described below.

### Construction of Ply Layers

A. Needled Roving Ply

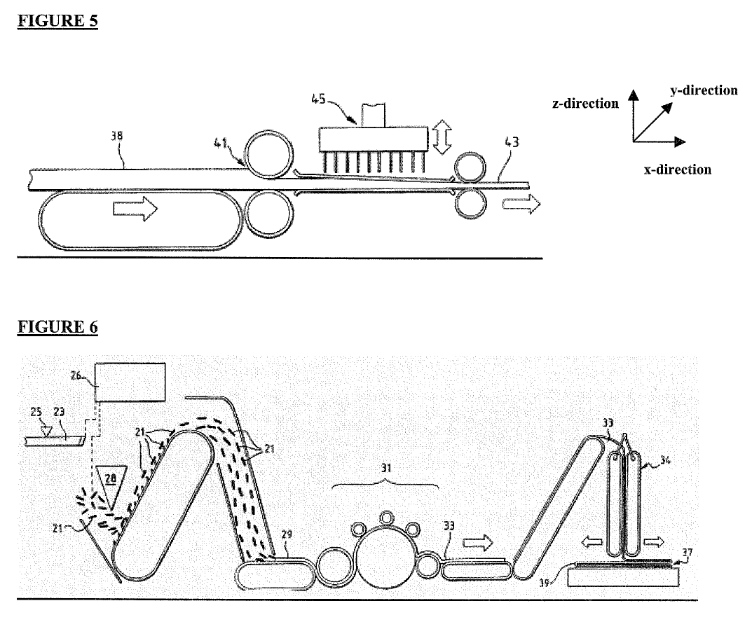

In order to form the needled roving ply 110, the homogenous fiber mass 29 is needle punched, as shown in FIG. 5. The loose roving fibers 38 are fed through a suitable nip 41 and needle-punched by conventional textile apparatus 45 to form the needled roving ply 110. The needling of the multiple loose roving fibers 38 interengage the fibers 300 of respective layers of loose roving fibers 38, giving the resulting metal fabric 43 improved strength, fiber density, and fiber distribution characteristics for use in any of a variety of applications. The resulting fabric 43 thus has fibers interengaged in the z-direction to form a coherent metal ply structure. Generally speaking, the metal fabric ply includes an x, y, and z-direction, as shown in FIG. 5. The x-direction is the longitudinal machine direction in which the fabric ply exits the textile apparatus. The y-direction is the transverse machine direction in which the fabric ply exits the textile apparatus. And the z-direction is the vertical direction in which the fabric ply exits the textile apparatus. The bias direction is any other direction 0-90 degrees between the x, y, or z-direction.

B. Nonwoven Ply

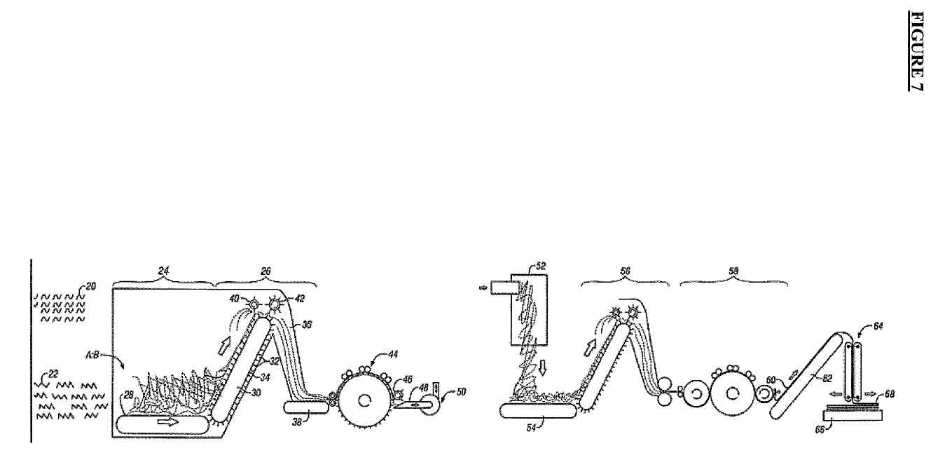

The nonwoven ply 120 is made by carding the homogenous fiber mass 29 of the metal fibers 21, as shown in FIG. 6. The homogenous fiber mass 29 is carded in the garnett 31 to form a fiber web 33, which is readily understood by commonly assigned U.S. Pat. No. 6,249,941. The garnett 31 may be any suitable apparatus used in the textile field, with the spacing/number of the cylinders and the garnett wires depending on the size and strength of the metal fibers 21 being acted upon. The carding process generally imparts a slight “machine direction” to the fibers 21, as that term is understood in the textile art. It is important that sufficient oil or other lubricant be retained on the fibers 21 of the homogenous fiber mass 29 so that when the web is processed by the garnett 31, there is no undesirable fracturing or disintegration of the web 29. After carding by the garnett 31, the fiber web 33 is lapped by suitable textile apparatus 34 to form a multi-layer structure 37. The lapping apparatus 34 preferably changes the orientation of the fiber web 33 as it is being deposited in successive layers. In this way, the orientation of adjacent ones of the layers 39 are rotated out of alignment from each other by a preselected angle, and the direction of the fibers 21 in the fiber web 33 varies between adjacent layers 39 of the resulting multi-layer structure 37. The multi-layer structure 37 is then fed through a suitable nip 41 and needled or needle-punched by conventional textile apparatus 45 to form a nonwoven metal fabric 43 shown in FIG. 5. The needling of the multiple layers 39 interengages the fibers 21 of respective layers 39, giving the resulting metal fabric 43 improved strength, fiber density, and fiber distribution characteristics for use in any of a variety of applications. The needling process causes the fibers 21 to be interengaged not only within respective layers 39 but also between the layers 39 (in the “z” direction relative to the layers). The resulting fabric 43 thus has the fibers 21 interengaged in the x, y, and z directions to form a suitably strong, coherent metal structure.

C. Composite Nonwoven Ply

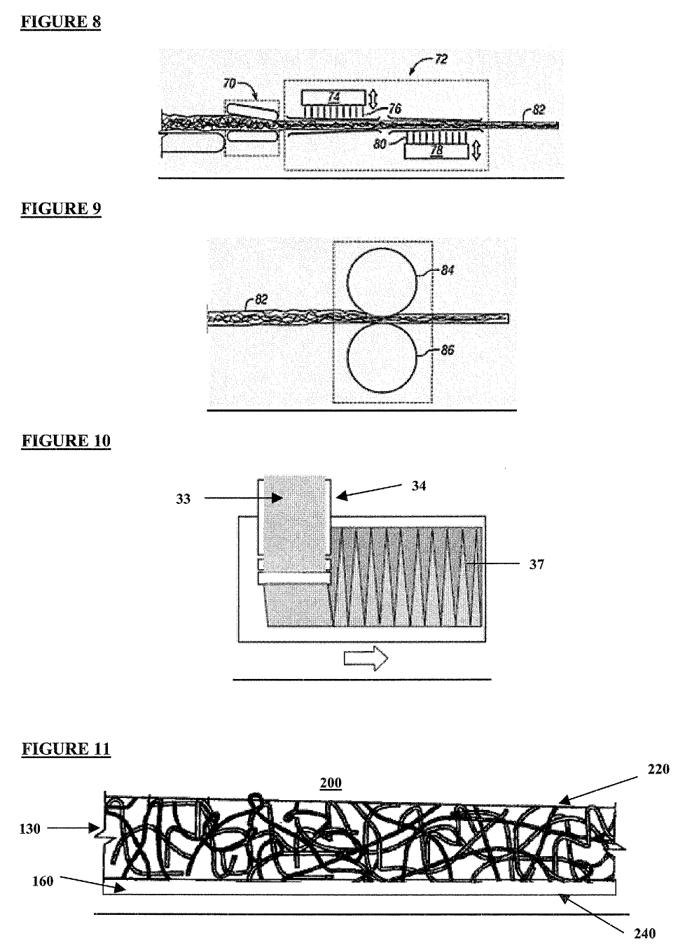

The composite nonwoven ply is made by blending a predetermined amount of metal fibers 20 and a predetermined amount of nonmetal fibers 22 to provide a blend of metal and nonmetal fibers; carding the blended fibers to form a composite fiber web having metal fibers and nonmetal fibers distributed throughout; and needle punching the web to interengaged the fibers in adjacent layers to provide the composite nonwoven ply, as shown in FIG. 7 and disclosed in commonly assigned U.S. Pat. No. 6,502,289, herein incorporated by reference. The nonmetal fiber may be essentially any synthetic or natural staple fibers conventionally used in the textile industry for making nonwoven fabric material, such as polypropylene, polyester, polyethylene, rayon, nylon, acetate, acrylic, cotton, wool, olefin, amide, polyamide, fiberglass and the like. The lengths of the nonmetal fibers may be from about 1 inch to about 12 inches, and are more preferably less than about 6 inches in length. The grade of the nonmetal fibers may range from about 1 denier to about 120 denier, more preferably from about 10 to 80 denier and most preferably about 18 to 60 denier. In general, the metal fibers will have an average cross-sectional diameter that is from ½ to 2-times the cross-sectional diameter of the nonmetal fibers. More preferably, the metal fibers and nonmetal fibers will have similar average diameters and lengths. A presently preferred composite nonwoven fabric comprises synthetic polymer fibers, such as polyester or polypropylene fibers, having a grade of about 60 denier and metal fibers having an average cross section of about 60 microns. Crimped synthetic fibers having a repeating “V” shape along their length. Crimped synthetic fibers having about 3 to 10 “V” shaped crimps per inch are preferred as the nonmetal fibers in the composite nonwoven fabrics of the present invention, with crimped fibers having about 7 crimps per inch being the most preferred. Of course, a greater or lesser degree of crimping may be selected as the particular application demands. Such crimped synthetic fibers are generally employed because they are readily carded by a garnett or carding machine. The composite nonwoven ply can have a ratio of metal fibers to non-metal fibers of between about 10:1 and about 1:99 by weight. In one embodiment of the invention, the composite nonwoven ply comprises about 75-95 wt. % metal fibers and about 5 to 25 wt. % nonmetal fibers.

For the composite nonwoven ply, the metal fibers 20 and nonmetal fibers 22 are blended prior to the carding step to obtain a substantially homogeneous mixture of the fibers, as disclosed in the U.S. Pat. No. 6,502,289. In one embodiment, a predetermined weight of staple length, shaved stainless steel fibers 20 (60 micron average diameter, 0.6% oil by weight) and staple length polyester fibers 22 (60 denier, 7 crimps per inch) are introduced into the hopper 24 of feedbox 26 in a ratio of about 91 wt. % metal fibers (including oil) to 9 wt. % nonmetal fibers. The hopper has a hopper conveyor 28 that conveys the fibers to incline conveyor 30 having tines 32 extending from the conveyor belt 34 so as to engage and carrying randomly oriented fibers 20, 22 up the incline conveyor 30. The feedbox 26 has a first spiked roller 40 which is spaced apart from incline conveyor 30 by a predetermined amount and rotates counter to the direction of travel of the incline conveyor 30. Incline conveyor 30 and first spiked roller 40 comb the material to allow only a certain small amount of generally parallel fibers in a loose unstructured web to pass into chute 36. A second spiked roller 42 rotating in the direction of travel of the conveyor assists in removing the thin layer of fibers 20, 22 from the tines 32 of the conveyor. The combing action of the first spiked roller 40 removes excess fibers which are “recycled,” or knocked back into the feedbox for further blending, resulting in a satisfactory distribution of metal and non-metal fibers.

In FIG. 7, the individual fibers 20, 22 that pass under first spike roller 40 drop through chute 36 and onto precard conveyor 38 are then advanced through to precard apparatus 44 to form an open precard web 46 of loosely entwined fibers. As precard web 46 exits the precard apparatus, it is sucked into the intake 48 of the stock blower fan 50 and is blown into condenser box 52 causing the fibers 20, 22 of precard web 46 to be randomized. The fibers 20, 22 then exit the condenser box and are fed by second feedbox conveyor 54 into a second feedbox 56 (substantially identical to feedbox 26) which further mixes/blends fibers 20, 22.

The blend of fibers 20, 22 is fed from second feedbox 56 into a shaker chute, then into the garnett 58 and is formed into a composite web 60, as shown in FIG. 7. Composite web 60 is transported to the incline conveyor 62 into lapping apparatus 64 where composite web 60 is lapped to form a multi-layered structure 68. The lapping apparatus feeds the web 60 downwardly onto apron 66 while simultaneously moving the web from side to side in an oscillating motion (as depicted by the arrows) to cause the web material to invert and fold-over upon itself each time the oscillating lapper changes direction. While the lapping apparatus 64 deposits successive layers of the composite web 60 on top of each other, apron 66 advances slowly in a direction perpendicular the axis of oscillation so that the web 60 is laid down in a Z-shaped pattern as the fabric inverts and folds back upon itself. In this manner, a continuous-length of a multi-layered composite web structure 68 is formed. As will be appreciated by those having ordinary skill in the art, the lapping step causes adjacent layers of web 60 to be laid on top of each other at a preselected angle. Because the fibers in each layer are relatively aligned, the direction of the fibers in adjacent layers of the composite web runs on the bias with respect to one another. As will be appreciated, the number of layers in the multi-layered web structure 68 as well as the degree of the bias between adjacent layers will be a function of the following variables: (i) the speed at which the composite web 60 is advanced through the lapping apparatus 64; (ii) the frequency of oscillation of the lapping apparatus 64; (iii) the width of the composite web 60; and (iv) the apron speed. In the preferred embodiment the composite web 60 is advanced on the lapping apparatus 64 at a speed of 47 feet per minute, and the lapping machine is oscillated at between 2-10 oscillations per minute. The preferred width of the composite web is between 20 to 60 inches and the apron speed is set between 5 to 50 feet per minute. However, the material can be manufactured on larger textile equipment that can produce widths of material up to 200 inches.

The multi-layered web structure 68 is then fed through a compression apron 70, as shown in FIG. 8, to slightly compress the multi-layered structure 68, and needled by a needle-punch apparatus 72 to form a composite nonwoven fabric of the invention. The needle-punch apparatus comprises a first punch board 74 having a first set of barbed needles 76. First punch board 74 reciprocates up and down and punches the multi-layered composite web from the top side to interengage fibers on the down-stroke. The needle-punch 72 further comprises a second punch board 78 having a second set of barbed needles 80. Second punch board 78 reciprocates up and down and punches the multi-layered composite web from the underside to interengage fibers on the upstroke.

The composite nonwoven ply comprising synthetic polymer fibers optionally may be subjected to a heat-fusing step to fuse at least a portion of the fibers at their intersections. As shown in FIG. 9, a heat-fusing step may be carried out (i.e., after the needle-punching step) by heating the composite nonwoven fabric to a predetermined temperature that is at least equal to the melting point of the synthetic fibers, preferably to a temperature from about 10 to 50° C. or more above the melting point of the synthetic fibers. Heat is conducted to the composite nonwoven fabric for an amount of time (e.g., 1 to about 20 seconds or more) sufficient to cause the outer surface of the synthetic fibers to at least partially melt so that upon cooling the synthetic fibers fuse to other fibers with which they are in contact. With reference to FIG. 9, the heating step may be carried out by passing the composite nonwoven ply through a pinch roll apparatus comprising a heat-conductive roll 84 and a resilient (e.g., rubber) roll 86, with the clearance between the pinch rolls set to at least partially compress the composite nonwoven fabric while it is in contact with the heated pinch roll. The amount of time the composite nonwoven fabric spends in contact with the heated roll may be adjusted depending on the amount of melting of the synthetic fibers desired. It is presently preferred that the fabric contact the heated roll between 3 and 10 seconds. Other methods of heating and melting the synthetic fibers include compressed hot air, and direct radiant heating. As will be appreciated, the amount of fusion between the fibers will be greatest at the surface contacting the heated roller. Optionally, two or more such pinch roll devices may be used in series so that both surfaces of the composite nonwoven fabric are brought into direct contact with a heat conductive roll 84 to fuse the fibers of the composite nonwoven fabric. This heat fusing step may be used to laminate the scouring layer to the nonmetal layer, as detailed below.

D. Cross Layered Ply

As shown in FIG. 10, the cross layered ply 140 is made by lapping a layer of premade needled roving ply layers in a cross machine direction to form fibers into a bias oriented needle punched web. The lapping step is similar to previous lapping steps, where the fiber web 33 is lapped by suitable textile apparatus 34 to form a multi-layer structure 37. The lapping apparatus 34 preferably crosses the orientation of the fiber web 33 as it is being deposited in successive layers. In this way, the orientation of adjacent ones of the layers 39 are rotated out of alignment from each other by a preselected angle, and the direction of the fibers 21 in the fiber web 33 varies between adjacent layers 39 of the resulting multi-layer structure 37. The lapped layers are then needle punching together layers of fibers running in alternating directions, as previously indicated.

F. Polyester Scrim

The polyester scrim ply 160 is mechanically bonded polyester fibers of a given denier and basis weight. Mechanical bonding can be hydro-entanglement, air-jet entanglement, needle punching, needle stitching, or by any other mechanical bonding method known in the art. In one example, the polyester scrim ply 160 can have a basis weight of 120 g/m² and can be purchased commercially from National Nonwovens, Inc.

G. Spunbonded Adhesive Fiber Scrim

The spunbonded adhesive fiber scrim fiber ply 170 is a special thermally activated laminating adhesive in fiber web form made by the spunbonded process.

H. Nylon Scrim

The nylon scrim ply 180 is a woven textile made from nylon fibers of a given denier and basis weight. For example, the nylon scrim ply 180 can have a basis weight of 120 g/m².

The polyester scrim 160, the spunbonded adhesive fiber scrim 170, and the nylon scrim ply 180 may be incorporated into the scouring layer 200 to help anchor adjacent ply layers or help anchor the scouring layer to the nonmetal layer. The polyester scrim 160, the spunbonded adhesive fiber scrim 170, and the nylon scrim ply 180 may be present in the scouring layer 200 by mechanically bonding to adjacent ply layers, thermally bonding to adjacent ply layers, or chemically bonding to adjacent ply layers. Laminating the polyester scrim 160, the spunbonded adhesive fiber scrim 170, and the nylon scrim ply 180 to the metal ply layers 110-140 increases the strength and durability of the metal ply layers for scouring purposes. It should be appreciated that the scouring layer 200 of the invention can be constructed with any number of metal ply layers in any combination to achieve the desired performance of scouring a surface. As such, mechanical synergy can exist between multiple ply layers, whether the ply layers are adjacent or separated by other ply layers. Multiple ply layers can gain tensile strength from other supporting ply layers for increased stability and abrasiveness. Therefore, such ply layers can be laminated in an order where the scouring surface 220 has maximum scouring ability, and the laminating surface 240 includes ply layers with maximum laminating ability to the nonmetal layer 400. One of ordinary skill in the art can determine what scouring application requires which ply layers and adjust them and combine them accordingly. Increasing the number of ply layers may increase the overall abrasiveness of the multilayer laminate. Below are several examples of the scouring layer 200, which are laminated to the nonmetal layer 400.

### Scouring Layer Examples

In one embodiment of the invention, the scouring layer 200 includes one composite nonwoven ply 130, as shown in FIG. 1. Since only one ply layer is included, the composite nonwoven ply 130 is the scouring surface 220 and the laminating surface 240 of the scouring layer 200. The composite nonwoven ply 130 is laminated to the nonmetal layer 400 by known laminating processes. For example, the composite nonwoven ply 130 can be laminated to the nonmetal layer 400 by oven activation, where the nonmetal layer 400 melts onto the composite nonwoven ply 130. Alternatively, the composite nonwoven ply 130 can be laminated to the nonmetal layer 400 by adhesives such as epoxy resins and the like. Preferably, the composite nonwoven ply 130 includes metal fibers and 15 denier polyester fibers in a ratio of 9:1 with a total basis weight ranging from 700-1000 g/m².

In another embodiment, the scouring layer 200 includes the composite nonwoven ply 130 and the polyester scrim ply 160, as shown in FIG. 11. The scouring surface 220 includes the composite nonwoven ply 130 and the laminating surface 240 includes the polyester scrim ply 160. The composite nonwoven ply 130 can be laminated to the polyester scrim ply 160, and in one example the composite nonwoven ply 130 is needle laminated to the polyester scrim ply 160. And the polyester scrim ply 160 is laminated to the nonmetal layer 400, where the polyester scrim ply 160 provides for structural stability and adhesion for the composite nonwoven ply 130 in the scouring layer 200. Alternatively, the composite nonwoven ply 130 can be laminated to the polyester scrim ply 160 by any laminating methods. The composite nonwoven ply 130 can have a basis weight of 800-2000 g/m²; while the polyester scrim ply 160 can have a basis weight of 100-200 g/m². Therefore, the total weight of the composite nonwoven ply 130 and polyester scrim ply 160 can have a total basis weight of 900-2200 g/m².

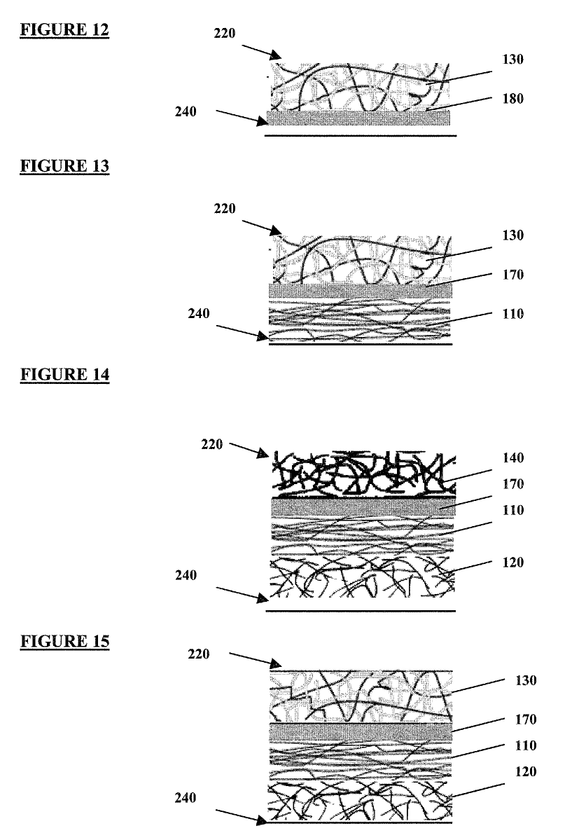

In another embodiment of the invention, the scouring layer 200 includes the composite nonwoven ply 130 and a nylon scrim ply 180, as shown in FIG. 12. The scouring surface 220 includes the composite nonwoven ply 130 and laminating surface 240 includes the nylon scrim ply 180. The composite nonwoven ply 130 preferably includes metal fibers and nonmetal fibers in a ratio of 9:1. The composite nonwoven ply 130 is laminated to the nylon scrim ply 180. For example, the composite nonwoven ply 130 can be needle laminated to the nylon scrim ply 180. Alternatively, the composite nonwoven ply 130 can be laminated to the polyester scrim ply 160 by any laminating methods. The composite nonwoven ply 130 can have a basis weight of 800-1000 g/m²; while the polyester scrim ply 160 can have a basis weight of 100-200 g/m². Therefore, the total weight of the composite nonwoven ply 130 and polyester scrim ply can have a total basis weight of 900-1200 g/m².

In another embodiment of the invention, the scouring layer 200 includes the needled roving ply 110, the spunbonded adhesive fiber scrim ply 170, and the composite nonwoven ply 130, as shown in FIG. 13. The scouring surface 220 includes the composite nonwoven ply 130, the laminating surface 240 includes needled roving ply 110, with the spunbonded adhesive fiber scrim ply 170 therebetween. The composite nonwoven ply 130, the spunbonded adhesive fiber scrim ply 170, and the needled roving ply 110 are laminated together. In one example, the composite nonwoven ply 130, the spunbonded adhesive fiber scrim ply 170, and the needled roving ply 110 are laminated by a contact heat process, such as the heat fusing step described in FIG. 9. Preferably, the composite nonwoven ply 130 includes nonmetal fibers of 18 denier, and metal fibers and nonmetal fiber in a ratio of 9:1. The needled roving ply 110 can have a basis weight of 200-500 g/m²; while the spunbonded adhesive fiber scrim ply 170 can have a basis weight of 30-50 g/m², and the composite nonwoven ply 130 can have a basis weight of 600-800 g/m². Therefore, the total basis weight can range from 830-1350 g/m².

In another embodiment of the invention, the scouring layer 200 includes the nonwoven ply 120, the needled roving ply 110, the spunbonded adhesive fiber scrim ply 170, and the cross layered ply 140, as shown in FIG. 14. The scouring surface 220 includes the cross layered ply 140 and the laminating surface 240 includes the nonwoven ply 120. The nonwoven ply 120 is manufactured onto the needled roving ply 110 to form a nonwoven-needled roving bilayer. The nonwoven-needled roving bilayer is rolled onto the spunbonded adhesive fiber scrim ply 170, and then the cross layered ply 140 is manufactured onto the spunbonded adhesive fiber scrim ply 170. The cross layered ply 140 is laminated onto the spunbonded adhesive fiber scrim ply 170 and the nonwoven-needled roving bilayer. In one example, the cross layered ply 140 is needle laminated onto the spunbonded adhesive fiber scrim ply 170 and the nonwoven-needled roving bilayer. Thereafter, all the ply layers are laminated together to form the scouring layer 200. In one example, the ply layers are heat bonded on a fusion bonder, as described previously.

In another embodiment of the invention, the scouring layer 200 includes the nonwoven ply 120, a needled roving ply 110, the spunbonded adhesive fiber scrim ply 170, and the composite nonwoven ply 130, as shown in FIG. 15. The scouring surface 220 includes the composite nonwoven ply 130 and the laminating surface 240 includes the nonwoven ply 120. The nonwoven ply 120 is manufactured onto the needled roving ply 110 to form a nonwoven-needled roving bilayer. The nonwoven-needled roving bilayer is rolled onto the spunbonded adhesive fiber scrim ply 170, and the composite nonwoven ply 130 is manufactured onto the spunbonded adhesive fiber scrim ply 170. The composite nonwoven ply 130 is laminated onto the spunbonded adhesive fiber scrim ply 170 and the nonwoven-needled roving bilayer. In one example, the composite nonwoven ply 130 is needle laminated onto the spunbonded adhesive fiber scrim ply 170 and the nonwoven-needled roving bilayer. Thereafter all the ply layers are laminated together to form the scouring layer 200. In one example, the ply layers are heat laminated on the fusion bonder, as described previously.

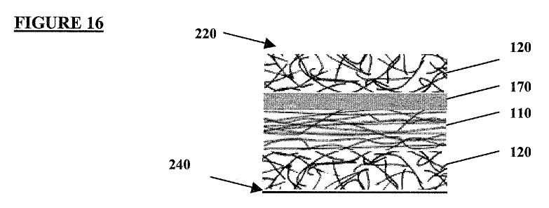

In another embodiment of the invention, the scouring layer 200 includes nonwoven ply 120, a needled roving ply 110, the spunbonded adhesive fiber scrim ply 170, and the needled roving ply 110, as shown in FIG. 16. The scouring surface 220 includes the needled roving ply 110 and the laminating surface 240 includes the nonwoven ply 120. The nonwoven ply 120 is manufactured onto the needled roving ply 110 to form a nonwoven-needled roving bilayer. The nonwoven-needled roving bilayer is rolled onto the spunbonded adhesive fiber scrim ply 170, where the needled roving ply 110 is manufactured onto the spunbonded adhesive 110 fiber scrim ply 170. The needled roving ply 110 is then laminated onto the spunbonded adhesive fiber scrim ply 170 and the nonwoven-needled roving bilayer. In one example, the needled roving ply 110 is needle laminated onto the spunbonded adhesive fiber scrim ply 170 and the nonwoven-needled roving bilayer. Thereafter all the ply layers are then laminated together to form the scouring layer 200. In one example, the ply layers are heat laminated on the fusion bonder, as described previously.

If desired, the scouring layer may optionally include various additives, such as cleaning agents, surfactants, soaps, detergentor medications, which may enhance the performance of the scouring layer.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A multilayer laminate comprising:
a. a scouring layer comprising at least one ply layer including an interengaged mixture of metal fibers, wherein the metal fibers include a rough barbed outer surface with irregular shaped cross-sections varied along the lengths of the metal fibers; and
b. a nonmetal layer laminated to the scouring layer to form a multilayer laminate.

2. The multilayer laminate of claim 1, wherein the ply layer comprises at least one composite nonwoven ply, wherein the composite nonwoven ply includes an interengaged mixture of metal fibers and nonmetal fibers, and the metal fibers include a rough barbed outer surface with irregular shaped cross-sections varied along the lengths of the metal fibers.

3. The multilayer laminate of claim 1, wherein the ply layer comprises at least one nonwoven ply, wherein the nonwoven ply includes an interengaged mixture of metal fibers, wherein the metal fibers are oriented isotropically.

4. The multilayer laminate of claim 1, wherein the ply layer comprises at least one cross layered ply, wherein the cross layered ply includes a plurality of continuous metal fibers lapped in a cross-machine direction to form metal fibers into a bias-oriented needle punched web.

5. The multilayer laminate of claim 1, wherein the ply layer comprises at least one spunbonded adhesive fiber scrim ply, at least one nylon scrim ply, or at least one polyester scrim ply.

6. The multilayer laminate of claim 1, wherein the scouring layer includes a first ply layer and a second ply layer, wherein the first ply layer comprises a composite nonwoven ply of interengaged mixture of metal and nonmetal fibers and the second layer comprises a nylon scrim ply of woven nylon fibers.

7. The multilayer laminate of claim 1, wherein the scouring layer includes a first ply layer and a second ply layer, wherein the first ply layer comprises a composite nonwoven ply including an interengaged mixture of metal and nonmetal fibers and the second ply layer comprises a polyester scrim ply of mechanically bonded polyester fibers.

8. The multilayer laminate of claim 1, wherein the scouring layer includes a scouring surface and a laminating surface; the scouring layer comprises at least one composite nonwoven ply including an interengaged mixture of metal and nonmetal fibers, at least one spunbonded adhesive fiber scrim ply, and at least one needled roving ply including an interengaged mixture of metal fibers; wherein the scouring surface includes the composite nonwoven ply, and the laminating surface includes the needled roving ply, and the ply layers are arranged therebetween.

9. The multilayer laminate of claim 1, wherein the scouring layer includes a scouring surface and a laminating surface; the scouring layer comprises at least one cross layered ply including a plurality of continuous metal fibers lapped in a cross-machine direction to form metal fibers into a bias-oriented needle punched web, at least one spunbonded adhesive fiber scrim ply, at least one needled roving ply including an interengaged mixture of metal fibers, and at least one nonwoven ply including an interengaged mixture of metal fibers; wherein the scouring surface includes the cross layered ply, the laminating surface includes the nonwoven ply, and the ply layers are arranged therebetween.

10. The multilayer laminate of claim 1, wherein the scouring layer includes a scouring surface and a laminating surface; the scouring layer comprises at least one composite nonwoven ply including an interengaged mixture of metal and nonmetal fibers, at least one spunbonded adhesive fiber scrim ply, at least one needled roving ply including an interengaged mixture of metal fibers, and at least one nonwoven ply including an interengaged mixture of metal fibers; wherein the scouring surface includes the composite nonwoven ply, the laminating surface includes the nonwoven ply, and the ply layers are arranged therebetween.

11. The multilayer laminate of claim 1, wherein the scouring layer includes a scouring surface and a laminating surface; the scouring layer comprises at least one needled roving ply including an interengaged mixture of metal fibers, at least one spunbonded adhesive fiber scrim ply, and at least one nonwoven ply including an interengaged mixture of metal fibers; wherein the scouring surface includes the needled roving ply, the laminating surface includes the nonwoven ply, and the ply layers are arranged therebetween.

12. A multilayer laminate comprising:
a. a scouring layer including at least one homogenous web comprising at least two overlapping ply layers, wherein the adjacent layers are interengaged with one another; and the layers include an interengaged mixture of metal fibers, wherein the metal fibers have a rough outer surface with irregular shaped cross-sections that vary continuously along the length of the metal fiber; and
b. a nonmetal layer laminated to the homogenous web.

13. The multilayer laminate of claim 12, wherein the ply layer comprises a composite nonwoven ply layer including an interengaged mixture of metal and nonmetal fibers.

14. The multilayer laminate of claim 12, wherein the ply layer comprises a nonwoven ply including isotropically oriented metal fibers.

15. The multilayer laminate of claim 12, wherein the scouring layer further comprises at least one polyester scrim ply, at least one nylon scrim ply, or at least one polyester scrim ply.

16. The multilayer laminate of claim 15, wherein the ply layer comprises a cross layered ply layer, wherein the adjacent layers are cross machined direction to form a bias oriented needle punched web; and the cross layered web is laminated to the nonwoven ply web.

17. The multilayer laminate of claim 12, wherein the scouring layer further comprises at least one spunbonded adhesive fiber scrim ply.

18. The multilayer laminate of claim 12, where the ply layer comprises a needled roving ply layer, wherein the needled roving ply includes continuous needle punched metal fibers approximately parallel in one direction.

19. A method of making a multilayer laminate comprising the steps of:
a. forming at least one ply layer with a plurality of metal fibers having barbed rough outer surfaces and irregular cross sectional diameters varying along the length of the metal fibers;
b. incorporating the ply layer into a scouring layer with a scouring surface and a laminating surface; and
c. laminating the laminating surface to a nonmetal layer.

20. The method of making the multilayer laminate of claim 19, wherein the forming the ply layer step further comprises:
a. providing a mass of loose metal fibers having barbed rough outer surfaces and irregular cross-sectional diameters varying along the length of the fibers;
b. applying a lubricant to the metal fibers in sufficient quantities so that irregular cross sections and barbed rough outer surfaces retain the lubricant and the lubricant substantially coats the metal fibers;
c. forming an approximately parallel oriented fiber mass of the lubricated metal fibers;
d. needle punching the approximately parallel oriented fiber mass to interengage the fibers and to form at least one needled roving ply; and
e. laminating the needled roving ply to the nonmetal layer.

21. The method of making the multilayer laminate of claim 19, wherein the forming the ply layer step further comprises:
a. providing a mass of loose metal fibers having barbed rough outer surfaces and irregular cross-sectional diameters varying along the length of the fibers;
b. applying a lubricant to the metal fibers in sufficient quantities so that irregular cross sections and barbed rough outer surfaces retain the lubricant and the lubricant substantially coats the metal fibers;
c. forming a homogenous fiber mass from the lubricated metal fibers with a textile apparatus;
d. carding the lubricated fibers on a garnett to form a fiber web;
e. lapping the fiber web to form multiple layers of the fiber web; and
f. needle punching the multiple layers to interengage the fibers of respective layers to form at least one nonwoven ply.

22. The method of making the multilayer laminate of claim 19, wherein the forming the ply layer step further comprises:
a. providing a mass of loose nonmetal fibers and metal fibers;
b. applying a lubricant to the metal fibers in sufficient quantities so that irregular cross sections and barbed rough outer surfaces retain the lubricant and the lubricant substantially coats the metal fibers;
c. forming a homogenous fiber mass from the lubricated metal fibers and the nonmetal fibers with a textile apparatus;
d. carding the lubricated metal fibers and the nonmetal fibers on a garnett to form a fiber web;
e. lapping the fiber web to form multiple layers of the fiber web; and
f. needle punching the multiple layers to interengage the fibers of respective layers to form at least one composite nonwoven ply.

23. The method of making the multilayer laminate of claim 19, wherein the forming the ply layer step further comprises:
a. providing a mass of loose metal fibers having barbed rough outer surfaces and irregular cross-sectional diameters varying along the length of the fibers;
b. applying a lubricant to the metal fibers in sufficient quantities so that irregular cross sections and barbed rough outer surfaces retain the lubricant and the lubricant substantially coats the metal fibers;
c. forming an approximately parallel oriented fiber mass of the lubricated metal fibers;
d. lapping the approximately parallel oriented fiber mass in a crossing orientation to vary the approximately parallel oriented fiber mass between adjacent layers to form a multilayer structure; and
e. needle punching the multilayer structure to interengage the fibers of the respective layers to form at least one cross layered ply.
